(19) United States
(12) Patent Application Publication
(10) Pub. No.: US 2024/0259516 A1
(43) Pub. Date: Aug. 1, 2024

(54) VIDEO PROCESSING DEVICE, COMPUTER-READABLE RECORDING MEDIUM, AND VIDEO PROCESSING METHOD

(71) Applicant: Roland Corporation, Shizuoka (JP)

(72) Inventors: Yoshihide Kasai, Shizuoka (JP); Kota Fujita, Shizuoka (JP)

(73) Assignee: Roland Corporation, Shizuoka (JP)

(21) Appl. No.: 18/418,345

(22) Filed: Jan. 22, 2024

(30) Foreign Application Priority Data
Jan. 27, 2023 (JP) 2023-011143

(51) Int. Cl. H04N 5/262; H04N 5/268

(52) U.S. Cl. CPC H04N 5/2624; H04N 5/268

(57) ABSTRACT

A video processing device outputting a composite video in which multiple media data are arranged includes an input terminal, a substitution display memory, and at least one processor. The substitution display memory stores substitution display data for each one of the input terminal. The substitution display data is composed of an image or a video representing a content of the media data that should be inputted in the input terminal. The at least one processor is configured to determine whether the media data has been normally inputted in the input terminal, and acquire the substitution display data corresponding to the input terminal from the substitution display memory and display, in the composite video, the substitution display data acquired corresponding to the input terminal in place of the media data from the input terminal, upon determining that the media data has not been normally inputted in the input terminal.

### CROSS-REFERENCE TO RELATED APPLICATION

This application claims the priority benefit of Japan application serial no. 2023-011143, filed on Jan. 27, 2023. The entirety of the above-mentioned patent application is hereby incorporated by reference herein and made a part of this specification.

### BACKGROUND

### Technical Field

The disclosure relates to a video processing device, a computer-readable recording medium, and a video processing method.

### Related Art

Patent Document 1 (Japanese Patent Application Laid-Open No. 2002-262179, e.g., paragraphs 0016 to 0019 and FIG. 1 to FIG. 4 of Patent Document 1) discloses a video mixer that has a plurality of video input channels and outputs an output video in which input videos inputted from each video input channel are arranged. In the case where an input video is not normally inputted from a video input channel (e.g., no signal), as disclosed in Patent Document 2 (Japanese Patent Application Laid-Open No. 2011-102842, e.g., paragraph 0074 of Patent Document 2), a “no-signal screen” in which the name of the video input channel or a wording indicating not being in a normally inputted state is provided in a solid blue screen is displayed at the position at which the input video of the video input channel is displayed in the output video. Accordingly, it is possible to allow a user to identify the video input channel that cannot be normally inputted.

However, although the no-signal screen of Patent Document 2 is provided with the name of the video input channel or the like, its content is unrelated to the content of the input video acquired from the corresponding video input channel. Thus, by simply looking at the no-signal screen, it is difficult for the user to learn what video should be inputted to the video input channel corresponding to the no-signal screen.

### SUMMARY

A video processing device according to an embodiment of the disclosure outputs a composite video, the composite video is a video in which a plurality of media data are arranged, and the media data is composed of an image and/or a video. The video processing device includes an input terminal, a substitution display memory, and at least one processor. The media data to be arranged in the composite video is inputted in the input terminal. The substitution display memory stores substitution display data for each one of the input terminal. The substitution display data is composed of an image or a video representing a content of the media data that should be inputted in the input terminal. The at least one processor is configured to: determine whether the media data has been normally inputted in the input terminal, and acquire the substitution display data corresponding to the input terminal from the substitution display memory and display, in the composite video, the substitution display data acquired corresponding to the input terminal in place of the media data from the input terminal, in a case of determining that the media data has not been normally inputted in the input terminal.

A computer-readable recording medium recording a video processing program according to an embodiment of the disclosure causes a computer including an input terminal and a memory to execute a processing of outputting a composite video. The composite video is a video in which a plurality of media data are arranged, and the media data is composed of an image and/or a video. The media data to be arranged in the composite video is inputted in the input terminal. The memory is operated as a substitution display memory that stores substitution display data for each of the input terminal, and the substitution display data is composed of an image or a video representing a content of the media data that should be inputted in the input terminal. The video processing program causes the computer to determine whether the media data has been normally inputted in the input terminal. The video processing program causes the computer to acquire, from the substitution display memory, the substitution display data corresponding to the input terminal, and display, in the composite video, the substitution display data acquired corresponding to the input terminal in place of the media data from the input terminal, in a case of determining that the media data has not been normally inputted in the input terminal.

Further, a video processing method according to an embodiment of the disclosure includes the following. It is determined whether a media data has been normally inputted from an input terminal. The media data is composed of an image and/or a video and is to be arranged in a composite video. A substitution display data corresponding to the input terminal is acquired in a case of determining that the media data has not been normally inputted from the input terminal. The substitution display data is composed of an image or a video representing a content of the media data that should be inputted in the input terminal. The substitution display data acquired corresponding to the input terminal is displayed in the composite video in place of the media data from the input terminal.

### BRIEF DESCRIPTION OF DRAWINGS

FIG. 1 is an external view of a video switcher.

FIG. 2A is a view showing setting screens displayed on LCDs. FIG. 2B to FIG. 2D are views representing no-signal thumbnails.

FIG. 3A is a view showing setting screens displayed on the LCDs in the case where media data cannot be normally acquired from video cameras. FIG. 3B is a view showing setting screens displayed on the LCDs in the case where media data cannot be normally acquired from the video camera and a presentation PC.

FIG. 4 is a functional block diagram of the video switcher.

FIG. 5 is a block diagram showing an electrical configuration of the video switcher.

FIG. 6A is a diagram schematically representing thumbnail data. FIG. 6B is a diagram schematically representing bank data. FIG. 6C is a diagram schematically representing use source data.

FIG. 7 is a flowchart of a main processing.

FIG. 8A is a flowchart of a preview display processing. FIG. 8B is a flowchart of a PVW output processing.

FIG. 9 is a flowchart of a PGM output processing.

FIG. 10A to FIG. 10C are respectively views showing composite videos in which no-signal thumbnails according to modification examples are displayed.

### DESCRIPTION OF EMBODIMENTS

Embodiments of the disclosure provide a video processing device, a video processing program, and a video processing method capable of allowing a user to easily learn what media data should be inputted to an input source inputting media data in the case where the media data to be arranged in a composite video cannot be normally acquired.

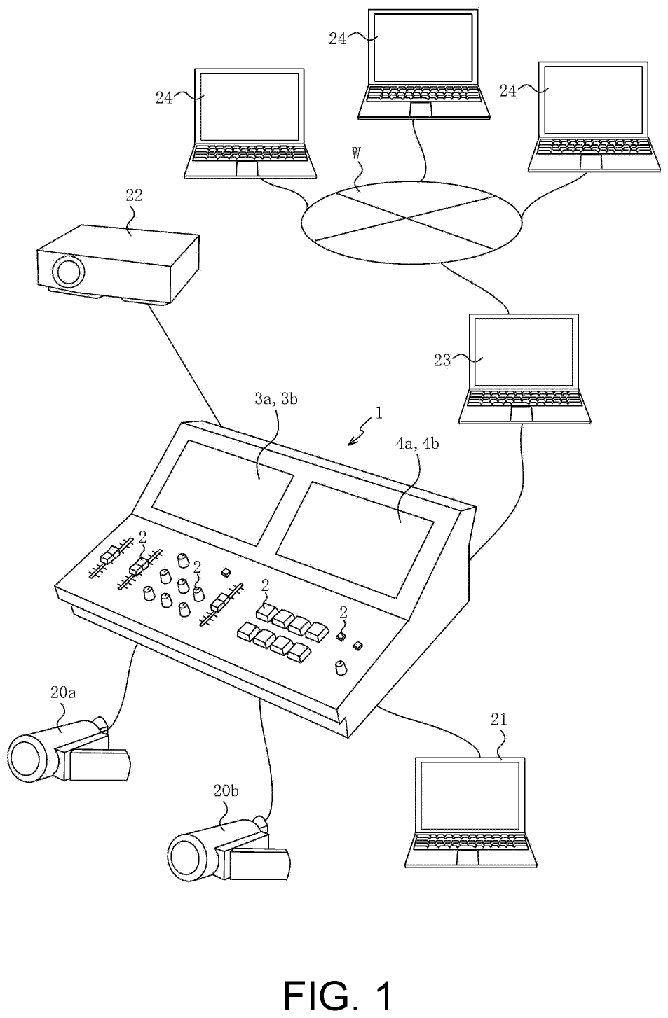

Hereinafter, exemplary embodiments will be described with reference to the accompanying drawings. Referring to FIG. 1, an outline of a video switcher 1 according to this embodiment will be described. FIG. 1 is a view illustrating an outline of the video switcher 1. The video switcher 1 is a device (video processing device) that outputs a composite video Sc obtained by arranging inputted images or videos in one video.

Video cameras 20a and 20b and a presentation PC 21, which output images or videos to be arranged in the composite video Sc, and a projector 22 and a distribution PC 23, which output the composite video Sc, are connected to the video switcher 1. The video cameras 20a and 20b are image capturing devices that output captured images or videos to the video switcher 1. The presentation PC 21 is an information processing device that outputs, to the video switcher 1, images or videos created by a user H with installed applications/software.

The projector 22 is an output device that projects the composite video Sc from the video switcher 1 onto a large screen. The distribution PC 23 is an information processing device that distributes, via the Internet W, the composite video Sc outputted from the video switcher 1. The composite video Sc distributed via the Internet W from the distribution PC 23 maybe viewed on a plurality of distribution destination PCs 24 connected to the Internet W. It is also possible to connect the video switcher 1 to the Internet W and directly distribute the composite video Sc from the video switcher 1 to the distribution destination PCs 24. In that case, the distribution PC 23 maybe omitted.

The video switcher 1 is provided with a “layer” for each input source, i.e., the video cameras 20a and 20b and the presentation PC 21, and in the layer, images or videos inputted from the corresponding input source are arranged. In each layer, images or videos inputted from the corresponding input source are arranged at sizes and positions specified by the user H. The composite video Sc is created by overlaying such layers. Hereinafter, images or videos arranged in a layer will be collectively referred to as “media data”.

The video switcher 1 is provided with setting buttons 2 for inputting instructions from the user H, a left touch panel 3a, a left LCD 3b, a right touch panel 4a, and a right LCD 4b. The left touch panel 3a is an input device for inputting a signal of a touched position according to a touch operation performed by the user H. The left LCD 3b is a display device that displays the layout of the composite video Sc to be outputted, and a like. The left touch panel 3a and the left LCD 3b are respectively arranged on the left side of the front surface of the video switcher 1, with the left touch panel 3a overlaid on the left LCD 3b.

Similarly, the right touch panel 4a is an input device for inputting a signal related to a touched position according to a touch operation performed by the user H, and the right LCD 4b is a display device that displays the layout of the composite video Sc to be outputted, and a like. The right touch panel 4a and the right LCD 4b are respectively arranged on the right side of the front surface of the video switcher 1, with the right touch panel 4a overlaid on the right LCD 4b.

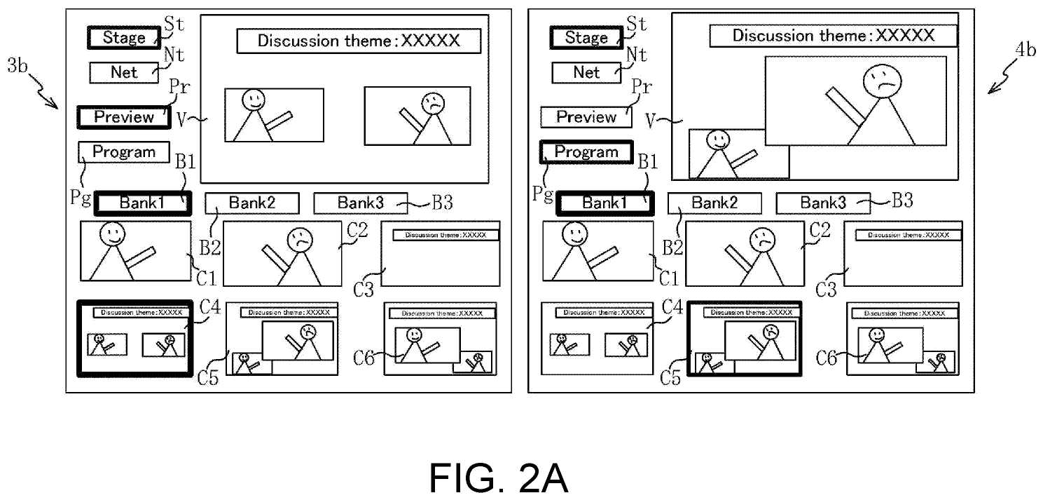

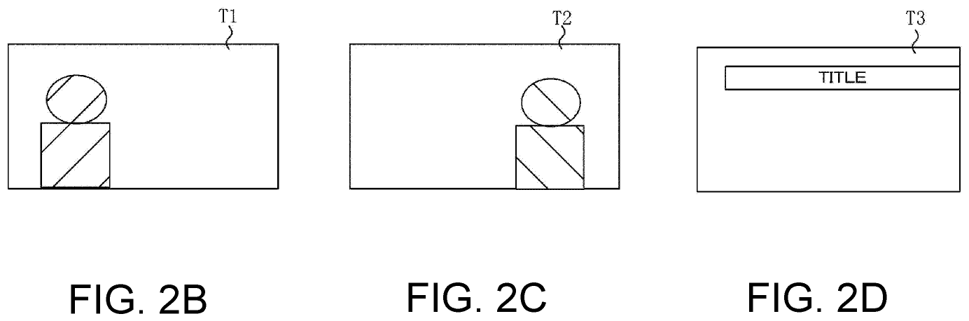

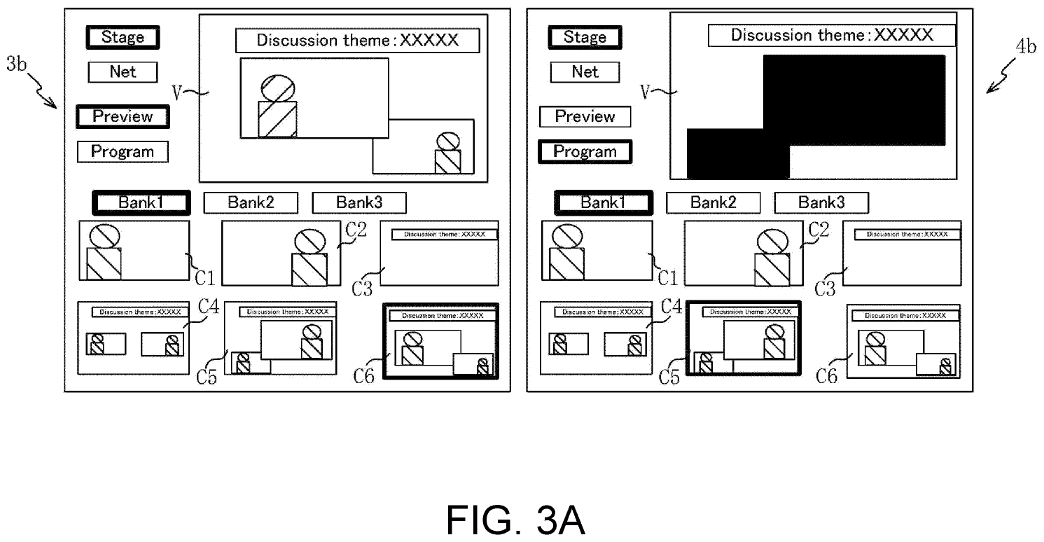

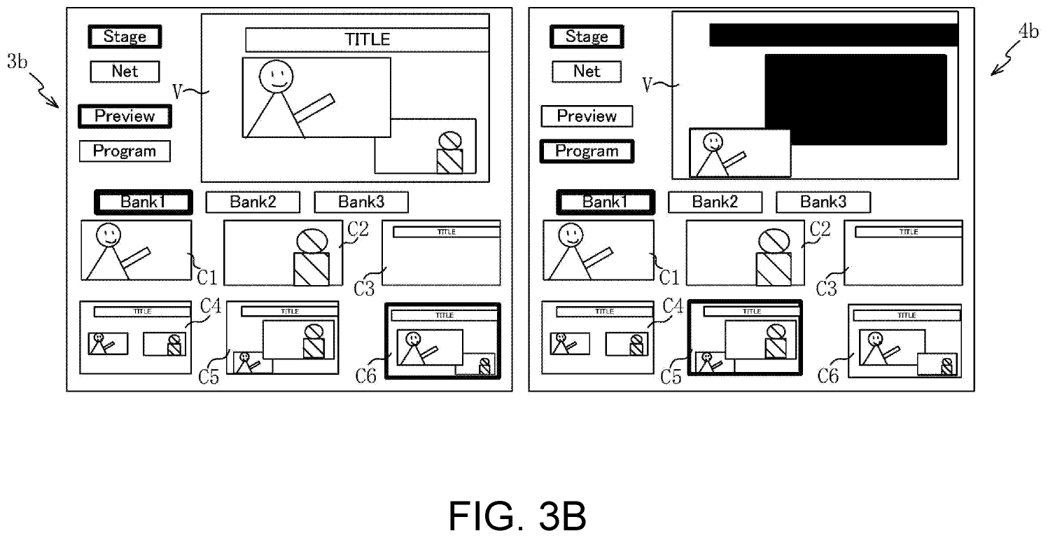

Next, referring to FIG. 2A to FIG. 3B, setting screens displayed when setting the composite video Sc displayed on the LCDs 3b and 4b will be described. FIG. 2A is a view showing setting screens displayed on the LCDs 3b and 4b. In FIG. 2A, the setting screen displayed on the left LCD 3b is shown on the left side, and the setting screen displayed on the right LCD 4b is shown on the right side. The same applies to subsequent figures.

The setting screens displayed on the LCDs 3b and 4b each display a display area V, a stage distribution button St, a net distribution button Nt, a preview output button Pr, a program output button Pg, preview buttons C1 to C6, and bank buttons B1 to B3. The display area V is a display area that displays a target composite video Sc.

The stage distribution button St is an operator for setting an output destination of the target composite video Sc to the projector 22 (e.g., arranged to project onto a screen on a stage of a concert venue). The net distribution button Nt is an operator for setting the output destination of the target composite video Sc to the distribution PC 23 distributing via the Internet W. The stage distribution button St and the net distribution button Nt are configured such that one of them can be selected.

The preview output button Pr is an operator for setting a setting mode to a “preview output”. The program output button Pg is an operator for setting the setting mode to a “program output”. The preview output button Pr and the program output button Pg are configured such that one of them can be selected.

In this embodiment, the setting mode of the video switcher 1 includes the “preview output”, which is a mode for setting the configuration of the composite video Sc without outputting the target composite video Sc to the projector 22 and the distribution PC 23, and the “program output”, which outputs the target composite video Sc to the projector 22 or the distribution PC 23. Also, in this embodiment, the setting mode is configured to be capable of being independently set on each of the left LCD 3b and the right LCD 4b.

For example, in the left LCD 3b in FIG. 2A, since the preview output button Pr is selected, the composite video Sc displayed in the display area V of the left LCD 3b is not outputted to the projector 22 and the distribution PC 23. In contrast, in the right LCD 4b in FIG. 2A, since the program output button Pg is selected and the stage distribution button St is selected, the composite video Sc displayed in the display area V of the right LCD 4b is outputted to the projector 22.

The preview buttons C1 to C6 are operators for selecting scene information for creating the composite video Sc to be displayed in the display area V and outputted to the projector 22 or the distribution PC 23. The preview buttons C1 to C6 are configured such that one of them can be selected. In this embodiment, the video switcher 1 stores scene information, which is information for constructing the composite video Sc, from images or videos inputted from the video cameras 20a and 20b and the presentation PC 21. The scene information is set with information such as sizes and arrangement positions of inputted images or videos for constructing the composite video Sc.

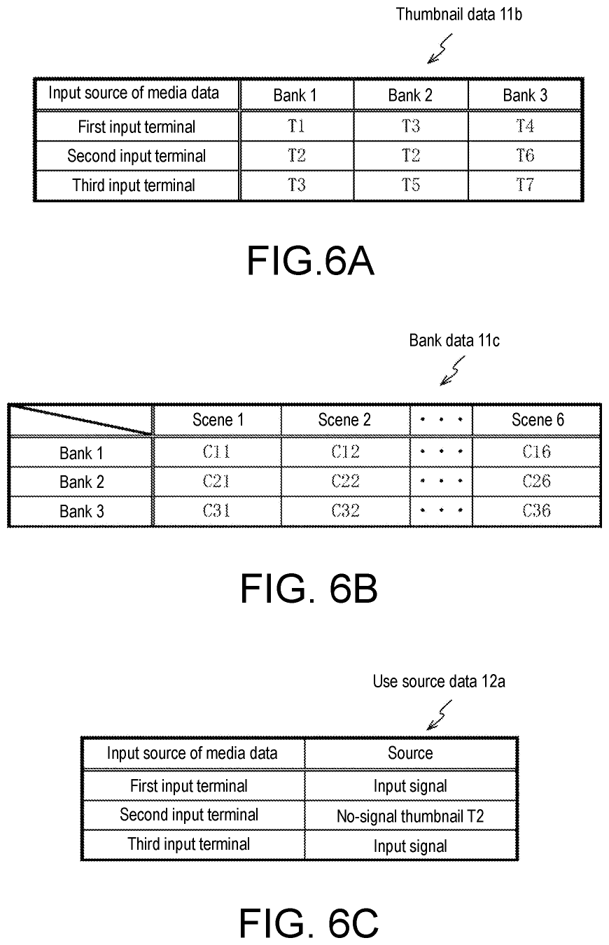

Six pieces of scene information are stored in a region called a bank. Furthermore, since the video switcher 1 is provided with three banks, a total of 18 pieces of scene information are stored in the video switcher 1 (see FIG. 6B). In the bank, the scene information is stored in a predetermined order, and the scene information with the same order in the respective banks stores scene information in similar forms, i.e., scene information with similar arrangements of images or videos. For example, 1st scene information in “Bank 1”, which is the 1st bank, and 1st scene information in “Bank 2”, which is the 2nd bank, each store scene information in similar forms.

Hereinafter, a number assigned to each scene information in the bank will be referred to as a “scene number”. The preview button C1 corresponds to the scene information with the scene number “1”, i.e., the scene information stored first in the set bank. The preview button C2 corresponds to the scene information with the scene number “2”. Similarly, the preview buttons C3 to C6 respectively correspond to the scene information with the scene numbers “3” to “6”.

In this embodiment, the scene information stored in a bank is not limited to six pieces, but may also be more than six pieces or less than six pieces. Also, the quantity of banks provided in the video switcher 1 is not limited to three, but may be more than three or less than three.

On the preview buttons C1 to C6, the composite videos Sc created from the scene information stored in the bank selected by bank buttons B1 to B3 (to be described later) are displayed as “thumbnails”. In this embodiment, six pieces of scene information are stored in a bank, and the composite videos Sc created by the respective scene information are displayed on the preview buttons C1 to C6. With such thumbnails of the preview buttons C1 to C6, the user H may learn in advance about the form of the composite video Sc to be displayed in the display area V or to be outputted to the projector 22 or the distribution PC 23, by selecting the preview buttons C1 to C6.

The bank buttons B1 to B3 are operators for selecting which bank among the banks stored in the video switcher 1 is to be used. The bank buttons B1 to B3 are also configured such that one of them can be selected.

On the left LCD 3b, the stage distribution button St, the preview output button Pr, the bank button B1, and the preview button C4 are selected. Thus, the composite video Sc displayed in the display area V of the left LCD 3b is created based on the 4th scene information in the 1st bank. Although the output destination of this composite video Sc is the projector 22, since the setting mode is the “preview output”, the composite video Sc is not outputted to the projector 22 but is only outputted to the display area V of the left LCD 3b.

On the right LCD 4b, the stage distribution button St, the program output button Pg, the bank button B1, and the preview button C5 are selected. Thus, the composite video Sc displayed in the display area V of the right LCD 4b is created based on the 5th scene information in the 1st bank. Since the output destination is the projector 22 and the setting mode is the “program output”, the composite video Sc is outputted to each of the display area V of the left LCD 3b and the projector 22.

In this manner, on the LCDs 3b and 4b, the composite videos Sc are displayed in the display area V and on the preview buttons C1 to C6. However, in the case where media data (images or videos) are not normally inputted from the video cameras 20a and 20b or the presentation PC 21, i.e., from the input source of the composite video Sc, a meaningless image such as a solid black image is displayed in a display region, in the composite video Sc, corresponding to the media data that is not normally inputted. In such a state, it is difficult for the user H to learn what media data should be supplied to the input source that is not normally inputted.

Thus, in this embodiment, in the case where there is an input source that does not normally input media data to the composite video Sc displayed on the preview buttons C1 to C6 and in the display area V of the LCDs 3b and 4b on which the setting mode is the “preview output”, a “no-signal thumbnail (substitution display data)” composed of an image or a video representing the content of the media data that should be inputted by the input source is displayed in a display region in which the media data inputted by the input source is to be displayed. Referring to FIG. 2B to FIG. 2D, the no-signal thumbnail will be described.

FIG. 2B to FIG. 2D are views respectively showing no-signal thumbnails T1 to T3. The no-signal thumbnail T1 in FIG. 2B is an image displayed in the case where the media data cannot be normally acquired from the video camera 20a. The no-signal thumbnail T2 in FIG. 2C is an image displayed in the case where the media data cannot be normally acquired from the video camera 20b. The no-signal thumbnail T3 in FIG. 2D is an image displayed in the case where the media data cannot be normally acquired from the presentation PC 21. In other words, in this embodiment, the no-signal thumbnails T1 to T3 are provided for each of the video cameras 20a and 20b and the presentation PC 21 from which the media data is acquired.

The no-signal thumbnails T1 and T2 are represented by images in forms corresponding to the shooting ranges and the angles of view that should be captured by the video cameras 20a and 20b, respectively. For example, in the case where the video camera 20a is a camera that captures a video with a person arranged on the left side of its shooting range, an image with a picture (graphic) of a person represented on the left side of the region is set as the no-signal thumbnail T1 corresponding to the video camera 20a. Similarly, in the case where the video camera 20b is a camera that captures a video with a person arranged on the right side of its shooting range, an image with a picture of a person represented on the right side of the region is set as the no-signal thumbnail T2 corresponding to the video camera 20b.

Further, the no-signal thumbnail T3 is represented by an image in a form corresponding to the image outputted by the presentation PC 21. For example, in the case where the presentation PC 21 outputs a band-shaped image containing a string representing a title of the composite video Sc, an image in which a picture of a generic string (e.g., “TITLE” as in FIG. 2D) is represented in a band-shaped image is set as the corresponding no-signal thumbnail T3. Thus, the no-signal thumbnails T1 to T3 display contents representing the media data that should be inputted by the respective input sources.

In the case where the movement of a person or the like in the videos captured by the video cameras 20a and 20b is known in advance, animated videos of this movement may be used as the no-signal thumbnails T1 and T2. Similarly, in the case where a video with a movement is outputted from the presentation PC 21 and the movement in this video is known in advance, an animated video of this movement may be used as the no-signal thumbnail T3.

In the case where media data cannot be normally acquired from the input source, in place of the media data inputted from the input source, such no-signal thumbnails T1 to T3 are displayed in the composite videos Sc of the preview buttons C1 to C6 and the display area V of the LCDs 3b and 4b on which the setting mode is the “preview output”. Referring to FIG. 3A and FIG. 3B, the setting screens of the LCDs 3b and 4b in the case where media data cannot be normally acquired will be described.

FIG. 3A is a view showing the setting screens displayed on the LCDs 3b and 4b in the case where media data cannot be normally acquired from the video cameras 20a and 20b. FIG. 3B is a view showing the setting screens displayed on the LCDs 3b and 4b in the case where media data cannot be normally acquired from the video camera 20b and the presentation PC 21.

In FIG. 3A, since media data cannot be normally acquired from the video cameras 20a and 20b, the no-signal thumbnails T1 and T2 shown in FIG. 2B and FIG. 2C are displayed instead in display regions in which the media data acquired from the video cameras 20a and 20b are to be displayed in the composite videos Sc displayed respectively on the preview buttons C1 to C6. In addition, in the composite video Sc of the display area V of the left LCD 3b on which the preview output is selected as the setting mode, the no-signal thumbnails T1 and T2 are also displayed in display regions of the media data acquired from the video cameras 20a and 20b.

In FIG. 3B, since media data cannot be normally acquired from the video camera 20b and the presentation PC 21, the no-signal thumbnails T2 and T3 shown in FIG. 2C and FIG. 2D are respectively displayed instead in display regions of the media data acquired from the video camera 20b and the presentation PC 21 in the composite videos Sc of the preview buttons C1 to C6 and the display area V.

On the other hand, in FIG. 3A and FIG. 3B, in the display area V of the right LCD 4b on which the program output is selected as the setting mode, the no-signal thumbnails T1 to T3 are not displayed, and in the display region of the composite video Sc, the media data inputted from the respective input sources are displayed directly.

That is, in the “preview output” in which the composite video Sc displayed in the display area V is only on the LCDs 3b and 4b, in place of media data that cannot be normally acquired, the no-signal thumbnails T1 to T3 corresponding to the input sources of the media data are displayed. Thus, in the “preview output” mainly used for setting the composite video Sc, the user H can easily learn about the content of the media data corresponding to the no-signal thumbnails T1 to T3, and further easily learn what media data should be inputted to the corresponding input source.

Furthermore, in the composite videos Sc displayed on the preview buttons C1 to C6, the no-signal thumbnails T1 to T3 corresponding to the input sources of media data are also displayed in display regions of the media data that have not been normally acquired. Accordingly, although the no-signal thumbnails T1 to T3 are displayed on the preview buttons C1 to C6, the no-signal thumbnails T1 to T3 are display contents corresponding to the media data that should originally be inputted by the input sources in which the media data have not been normally acquired, so the user H can easily have an overview of the scene information corresponding to the preview buttons C1 to C6.

On the other hand, in the composite video Sc displayed in the display area V of the right LCD 4b on which the “program output” is selected as the setting mode, display of the no-signal thumbnails T1 to T3 is prohibited, and media data that cannot be normally acquired are displayed directly. Similarly, at the output destination (i.e., the projector 22) corresponding to the right LCD 4b, output of the no-signal thumbnails T1 to T3 is prohibited, and media data that cannot be normally acquired are outputted. Accordingly, it is possible to suppress a situation in which the no-signal thumbnails T1 to T3 used for setting the composite video Sc erroneously come into view of the viewers at the output destination.

In addition, the no-signal thumbnails T1 to T3 may also be displayed in the display area V of the LCDs 3b and 4b on which the “program output” is selected as the setting mode while the no-signal thumbnails T1 to T3 are not displayed at the output destination. Accordingly, it is possible to allow the user H to check the no-signal thumbnails T1 to T3 while suppressing a situation in which the unnecessary no-signal thumbnails T1 to T3 are displayed to the viewers.

In addition, the no-signal thumbnails T1 to T3 represent display contents corresponding to the media data that should be inputted by the corresponding input sources. Thus, when performing position alignment for arranging the video cameras 20a and 20b at predetermined positions, if the video cameras 20a and 20b are not connected to the video switcher 1, the no-signal thumbnails T1 to T3 of the shooting ranges and angles of view that should be captured by the video cameras 20a and 20b are displayed in the display area V of the LCDs 3b and 4b on which the preview output is selected as the setting mode of the video switcher 1. By referring to the no-signal thumbnails T1 to T3 in the display area V of the LCDs 3b and 4b, the user H can easily perform position alignment of the video cameras 20a and 20b.

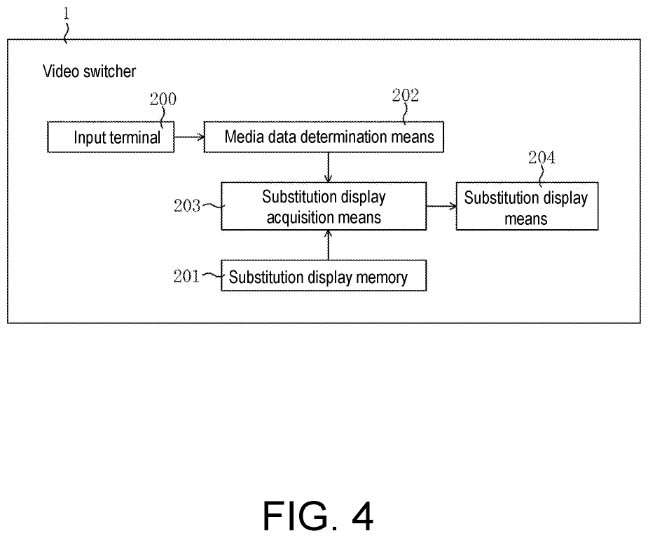

Next, referring to FIG. 4, the functions of the video switcher 1 will be described. FIG. 4 is a functional block diagram of the video switcher 1. As shown in FIG. 4, the video switcher 1 includes an input terminal 200, a substitution display memory 201, a media data determination means 202, a substitution display acquisition means 203, and a substitution display means 204. The media data determination means 202, the substitution display acquisition means 203, and the substitution display means 204 constitute a part of at least one processor.

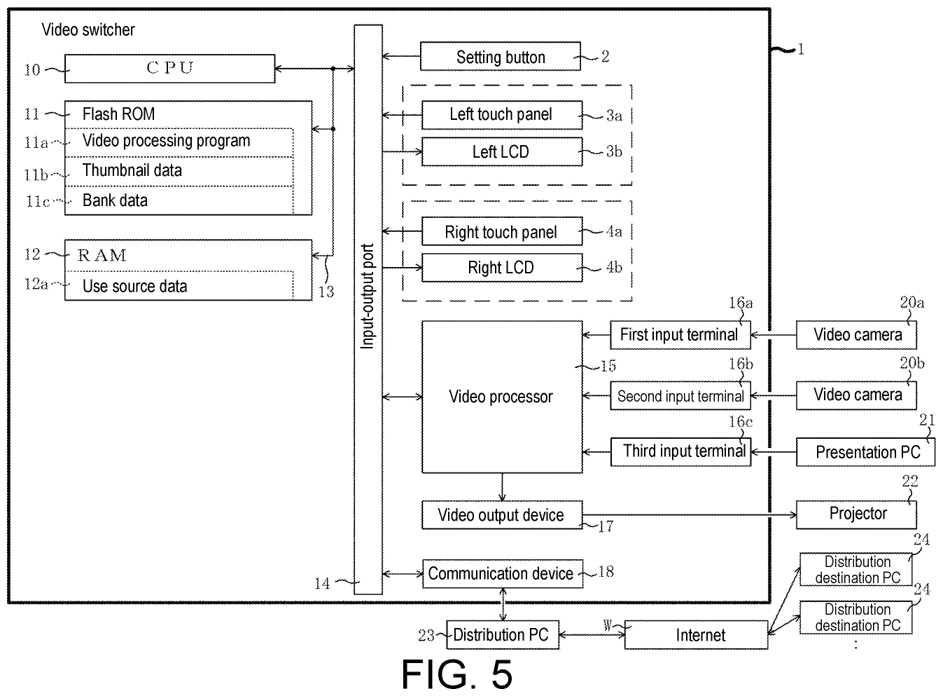

The input terminal 200 is a means that acquires media data to be arranged in a composite video Sc, and is realized by input terminals 16a to 16c to be described later with reference to FIG. 5. The substitution display memory 201 is a memory that stores, for each input terminal 200, a no-signal thumbnail of media data that should be inputted in the input terminal 200, and is realized by thumbnail data 11b to be described later with reference to FIG. 5 and FIG. 6A. The media data determination means 202 is a means that determines whether media data have been normally inputted in the input terminal 200, and is realized by a CPU 10 to be described later with reference to FIG. 5.

The substitution display acquisition means 203 is a means that acquires, from the substitution display memory 201, a no-signal thumbnail corresponding to an input terminal 200 that has been determined by the media data determination means 202 as not having been normally inputted. The substitution display acquisition means 203 is realized by the CPU 10. In the composite video, in place of a media data from an input terminal 200 that has been determined by the media data determination means 202 as not having been normally inputted, the substitution display means 204 displays the no-signal thumbnail corresponding to the input terminal 200 and acquired by the substitution display acquisition means 203. The substitution display means 204 is realized by the CPU 10. A part of or all of the substitution display acquisition means 203 and the substitution display means 204 may be realized by a video processor 15 and a video output device 17 (a part of an external output device) to be described later with reference to FIG. 5.

In the video switcher 1, for each input terminal 200, a no-signal thumbnail of media data that should be inputted in the input terminal 200 is stored, and it is determined whether the media data has been normally acquired by the input terminal 200. Then, a no-signal thumbnail corresponding to the input terminal 200 that has not normally acquired media data is acquired and is displayed in the composite video Sc in place of the media data from the input terminal 200 that has been determined as not having normally acquired media data.

In this manner, the no-signal thumbnail displayed in the composite video in place of the media data that has not been normally acquired by the input terminal 200 is composed of an image or a video representing the content that should be inputted in the input terminal 200. Accordingly, it is possible to allow the user H to easily learn what media data should be inputted to the input terminal 200 corresponding to such a no-signal thumbnail.

Next, referring to FIG. 5 to FIG. 6C, an electrical configuration of the video switcher 1 will be described. FIG. 5 is a block diagram showing the electrical configuration of the video switcher 1. As shown in FIG. 5, the video switcher 1 includes a CPU 10, a flash ROM 11 (memory, substitution display memory, bank memory), and a RAM 12, each of which is connected to an input-output port 14 via a bus line 13. Further, the setting button 2, the left touch panel 3a, the left LCD 3b, the right touch panel 4a, the right LCD 4b described above, a video processor 15, and a communication device 18 (a part of the external output device) are connected to the input-output port 14.

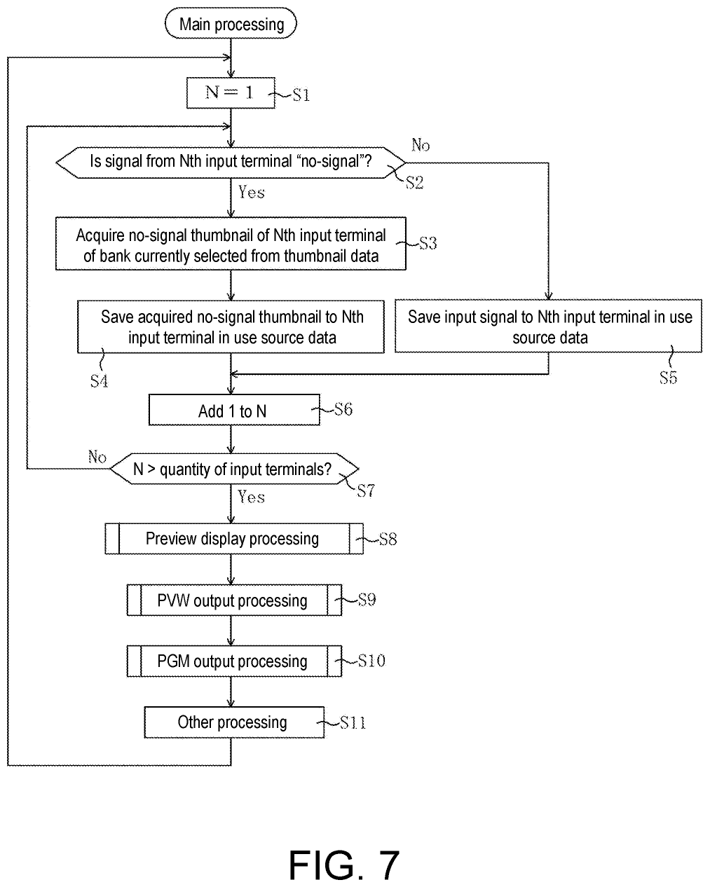

The CPU 10 is an arithmetic device that controls each part connected by the bus line 13. The flash ROM 11 is a rewritable non-volatile storage device that stores fixed value data and programs to be executed by the CPU 10, and stores a video processing program 11a, thumbnail data 11b, and bank data 11c. When the video processing program 11a is executed by the CPU 10, a main processing in FIG. 7 is executed. Details of the thumbnail data 11b and the bank data 11c will be described later with reference to FIG. 6A and FIG. 6B.

The RAM 12 is a memory for rewritably storing various work data, flags, etc., during execution of programs by the CPU 10, and is provided with use source data 12a. Herein, referring to FIG. 6A to FIG. 6C, the thumbnail data 11b, the bank data 11c, and the use source data 12a will be described.

FIG. 6A is a diagram schematically representing the thumbnail data 11b. As shown in FIG. 6A, in the thumbnail data 11b, corresponding no-signal thumbnails T1, T2, . . . , T7 are respectively stored for each input source of media data and each bank. The first input terminal 16a, the second input terminal 16b, and the third input terminal 16c respectively connected to the video cameras 20a and 20b and the presentation PC 21 (to be described later with reference to FIG. 5) are set as the input sources of media data in the thumbnail data 11b.

In this embodiment, no-signal thumbnails in different forms are set for each input source of media data as well as for each bank described above. In other words, the no-signal thumbnails are stored in the thumbnail data 11b for each input source which inputs media data and for each bank. Accordingly, a user H who has viewed a no-signal thumbnail in the composite videos Sc displayed on the preview buttons C1 to C6 and in the display area V of the left LCD 3b on which the preview output is selected as the setting mode can instantly learn the input source and the bank corresponding to the no-signal thumbnail.

FIG. 6B is a diagram schematically representing the bank data 11c. In the bank data 11c, a plurality of pieces of scene information are stored for each of a plurality of banks. In Bank 1, scene information C11, C12, . . . , C16 is stored for each scene number (Scene 1, Scene 2, . . . , Scene 6). Similarly, in Bank 2, scene information C21, . . . , C26 is stored for each scene number. In Bank 3, scene information C31, . . . , C36 is stored for each scene number. In this embodiment, the setting of the scene information is changeable by the user H, and the bank data 11c is configured such that the scene information with a setting changed by the user H is rewritable.

FIG. 6C is a diagram schematically representing the use source data 12a. As shown in FIG. 6C, the use source data 12a stores, for each input source, a source (information source) actually used in the composite videos Sc displayed on the preview buttons C1 to C6 and in the display area V of the left LCD 3b on which the preview output is selected as the setting mode.

“Input signal” and names of no-signal thumbnails such as “T2” are used as sources stored in the use source data 12a. In the case where “input signal” is stored as a source in the use source data 12a (e.g., the first input terminal 16a and the third input terminal 16c in FIG. 6C), an image or a video acquired by the input source is directly used in the composite video Sc. In contrast, in the case where a name of a no-signal thumbnail is stored as a source in the use source data 12a (e.g., the second input terminal 16b in FIG. 6C), in place of the image or the video acquired by the input source, the corresponding no-signal thumbnail is used in the composite video Sc.

Returning to FIG. 5, the video processor 15 is an arithmetic device that performs image processing according to an instruction from the CPU 10. The first input terminal 16a to the third input terminal 16c and the video output device 17 are connected to the video processor 15. Images or videos to be image-processed by the video processor 15 are inputted in the first input terminal 16a to the third input terminal 16c. The video output device 17 outputs images or videos such as composite videos Sc image-processed by the video processor 15.

The video camera 20a, the video camera 20b, and the presentation PC 21 described above are connected to the first input terminal 16a to the third input terminal 16c, and images or videos from the video camera 20a, the video camera 20b, and the presentation PC 21 are inputted to the video processor 15 via the first input terminal 16a to the third input terminal 16c. Further, the projector 22 is connected to the video output device 17, and respectively corresponding videos are outputted to the projector 22 via the video output device 17. At least a part of the video processor 15 and the video output device 17 maybe composed of electronic circuits such as field-programmable gate arrays (FPGAs) or dedicated LSIs.

The communication device 18 is a device for communicating with external devices, and particularly, is communicably connected with the distribution PC 23 described above. The distribution PC 23 is connected to the Internet W, and the distribution destination PCs 24 described above are connected to the Internet W.

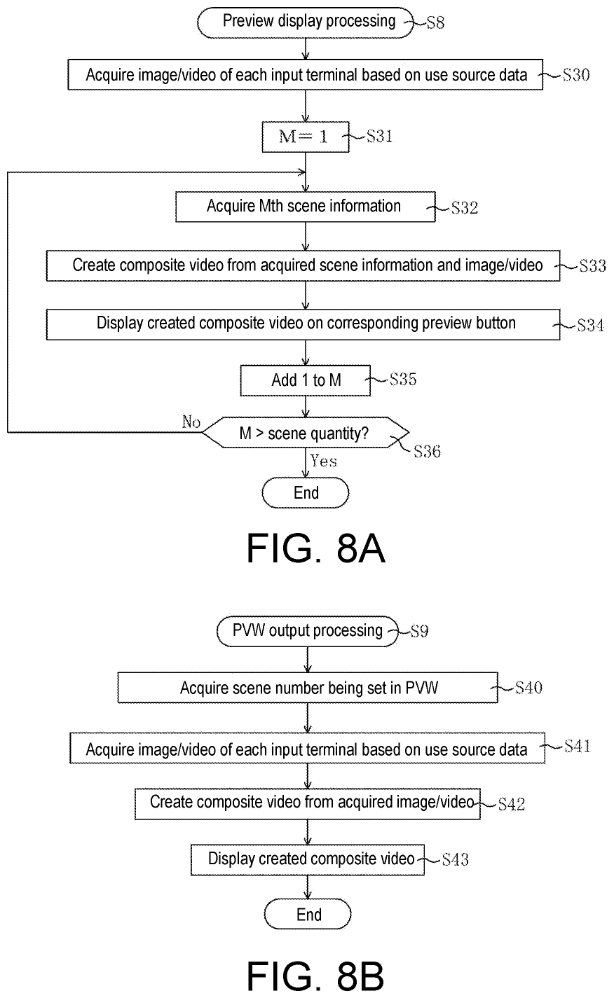

Next, referring to FIG. 7 to FIG. 8B, a processing executed by the CPU 10 of the video switcher 1 will be described. FIG. 7 is a flowchart of a main processing. The main processing is a processing executed in the case where the power supply of the video switcher 1 is turned on. In the main processing, first, 1 is set as a counter variable N (S1).

After the processing of S1, it is confirmed whether a signal from an Nth input terminal is “no-signal” (S2). Herein, the “Nth input terminal” refers to any of the first input terminal 16a to the third input terminal 16c. In the case where the counter variable N is 1, the “Nth input terminal” refers to the first input terminal 16a. In the case where the counter variable N is 2, the “Nth input terminal” refers to the second input terminal 16b. In the case where the counter variable N is 3, the “Nth input terminal” refers to the third input terminal 16c.

In the processing of S2, in the case where the signal from the Nth input terminal is “no-signal” (S2: Yes), it means that media data cannot be normally acquired from the Nth input terminal. In such a case, a no-signal thumbnail corresponding to the Nth input terminal of the bank currently selected by the bank buttons B1 to B3 on the LCDs 3b and 4b is acquired from the thumbnail data 11b (S3), and the acquired no-signal thumbnail is saved to a region corresponding to the Nth input terminal in the use source data 12a (S4).

On the other hand, in the processing of S2, in the case where the signal from the Nth input terminal is not “no-signal” (S2: No), “input signal” is saved to the region corresponding to the Nth input terminal in the use source data 12a (S5).

In the case where different banks are set on the LCDs 3b and 4b, the processings of S3 to S5 may be executed for each of the banks set on the left LCD 3b and the right LCD 4b, respectively. In such a case, the no-signal thumbnail or “input signal” to be stored to the use source data 12a may be distinguished and stored for the left LCD 3b and the right LCD 4b.

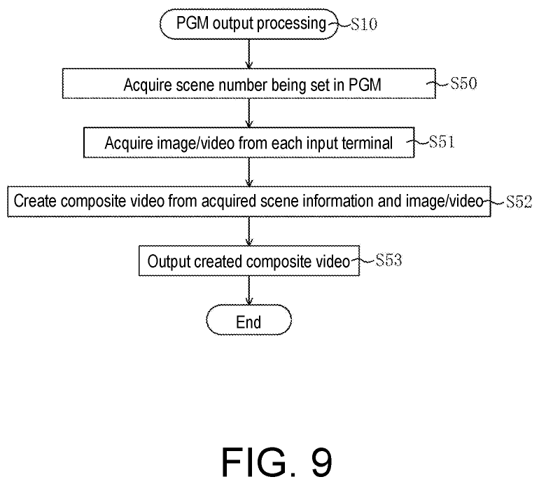

After the processings of S4 and S5, 1 is added to the counter variable N (S6), and it is confirmed whether the incremented counter variable N is larger than the quantity (i.e., “3”) of input terminals (S7). In the processing of S7, in the case where the counter variable N is less than or equal to the quantity of input terminals (S7: No), the processings from S2 onward are repeated. In the processing of S7, in the case where the counter variable N is larger than the quantity of input terminals (S7: Yes), a preview display processing of S8 is executed, a PVW output processing of S9 is executed, and a PGM output processing of S10 is executed. Herein, referring to FIG. 8A to FIG. 9, the preview display processing, the PVW output processing, and the PGM output processing will be described.

FIG. 8A is a flowchart of the preview display processing. The preview display processing is a processing for displaying composite videos Sc on the preview buttons C1 to C6 on the corresponding LCDs 3b and 4b. In the case where different banks are set on the LCDs 3b and 4b, the preview display processing may be executed for each of the banks set on the left LCD 3b and the right LCD 4b, respectively.

In the preview display processing, first, the media data or no-signal thumbnails of the first input terminal 16a, the second input terminal 16b, and the third input terminal 16c are acquired based on the use source data 12a (S30). Specifically, with respect to the first input terminal 16a, etc., for which “input signal” is set in the use source data 12a, a media data is acquired from the first input terminal 16a, etc. In contrast, with respect to the first input terminal 16a, etc., for which a “no-signal thumbnail” is set in the use source data 12a, the no-signal thumbnail set in the use source data 12a is acquired.

After the processing of S30, 1 is set as a counter variable M (S31). After the processing of S31, scene information of the scene number of M of the bank currently selected by the bank buttons B1 to B3 on the corresponding LCDs 3b and 4b is acquired from the bank data 11c (S32). After the processing of S32, a composite video Sc is created from the scene information acquired in the processing of S32 and the media data or the no-signal thumbnail acquired in the processing of S30 (S33). Specifically, the composite video Sc is created by arranging the media data or the no-signal thumbnail acquired in the processing of S30 at a size and an arrangement position of the media data set in the scene information acquired in the processing of S32.

After the processing of S33, the created composite video Sc is displayed on the corresponding preview buttons C1 to C6 (S34). For example, in the case where the counter variable M is “1”, the composite video Sc created in the processing of S33 is displayed on the preview button C1. In the case where the counter variable M is “6”, the composite video Sc created in the processing of S33 is displayed on the preview button C6.

After the processing of S34, 1 is added to the counter variable M (S35), and it is confirmed whether the incremented counter variable M is larger than the quantity (i.e., “6”) of scene information (S36). In the processing of S36, in the case where the counter variable M is less than or equal to the quantity of scene information (S36: No), the processings from S32 onward are repeated. On the other hand, in the case where the counter variable M is larger than the quantity of scene information (S36: Yes), the preview display processing is ended.

Next, referring to FIG. 8B, the PVW output processing will be described. FIG. 8B is a flowchart of the PVW output processing. The PVW output processing is a processing for creating a composite video Sc to be displayed in the display area V of the LCDs 3b and 4b on which the preview output is set as the setting mode, and displaying the composite video Sc in the display area V.

In the following, the bank buttons B1 to B3 and the preview buttons C1 to C6 specified in the PVW output processing correspond to the bank buttons B1 to B3 and the preview buttons C1 to C6 of the LCDs 3b and 4b on which the preview output is selected as the setting mode. In the case where the preview output is set on both the LCDs 3b and 4b, the PVW output processing may be executed according to the respectively set bank and scene information.

In the PVW output processing, first, a scene number corresponding to the preview buttons C1 to C6 currently selected on the corresponding LCDs 3b and 4b is acquired (S40). After the processing of S40, media data or no-signal thumbnails of the first input terminal 16a, the second input terminal 16b, and the third input terminal 16c are acquired based on the use source data 12a (S41). The acquisition method adopted in the processing of S41 is the same as that in the processing of S30 described above, so repeated descriptions will be omitted.

After the processing of S41, scene information of the scene number acquired in the processing of S40 of the bank currently selected by the bank buttons B1 to B3 on the corresponding LCDs 3b and 4b is acquired from the bank data 11c, and a composite video Sc is created from the acquired scene information and the media data or the no-signal thumbnail acquired in the processing of S41 (S42). The creation method adopted in the processing of S42 is the same as that in the processing of S33 described above, so repeated descriptions will be omitted. After the processing of S42, the created composite video Sc is displayed in the corresponding display area V (S43), and the PVW output processing is ended.

Next, referring to FIG. 9, the PGM output processing will be described. FIG. 9 is a flowchart of the PGM output processing. The PGM output processing is a processing for creating a composite video Sc to be displayed in the display area V of the LCDs 3b and 4b on which the program output is set as the setting mode, and outputting the composite video Sc to the display area V, the projector 22, and the distribution PC 23.

In the following, the bank buttons B1 to B3 and the preview buttons C1 to C6 specified in the PGM output processing correspond to the bank buttons B1 to B3 and the preview buttons C1 to C6 of the LCDs 3b and 4b on which the program output is selected as the setting mode. In the case where the program output is set on both the LCDs 3b and 4b, the PGM output processing may be executed according to the respectively set bank and scene information.

In the PGM output processing, first, a scene number corresponding to the preview buttons C1 to C6 currently selected on the corresponding LCDs 3b and 4b is acquire (S50). After the processing of S50, media data are acquired from the first input terminal 16a, the second input terminal 16b, and the third input terminal 16c, respectively (S51). After the processing of S51, scene information of the scene number acquired in the processing of S50 of the bank currently selected by the bank buttons B1 to B3 on the corresponding LCDs 3b and 4b is acquired from the bank data 11c, and a composite video Sc is created from the acquired scene information and the media data acquired in the processing of S51 (S52). The creation method adopted in the processing of S52 is also similar to that in the processing of S33 described above, so repeated descriptions will be omitted.

After the processing of S52, the created composite video Sc is displayed in the corresponding display area V and is outputted to the projector 22 or the distribution PC 23 (S53). In the processing of S53, in the case where the stage distribution button St is selected on the LCDs 3b and 4b on which the program output is set as the setting mode, the created composite video Sc is outputted to the projector 22 via the video processor 15 and the video output device 17. On the other hand, in the case where the net distribution button Nt is selected, the created composite video Sc is transmitted to the distribution PC 23 via the communication device 18, and is distributed to the distribution destination PCs 24 via the Internet W from the distribution PC 23. After the processing of S53, the PGM output processing is ended.

Returning to FIG. 7, after the PGM output processing of S10, other processing of the video switcher 1 is executed (S11), and the processings from S1 and onward are repeated.

Although the disclosure has been described based on the above embodiment, it can be easily inferred that various improvements and modifications are possible.

In the above embodiment, it has been described that the no-signal thumbnail represents the content of the media data that should be inputted by the corresponding input source, but the disclosure is not limited thereto. In addition to representing the content of the media data that should be inputted by the corresponding input source, the no-signal thumbnail may also be in a different form depending on the input source that inputs the media data.

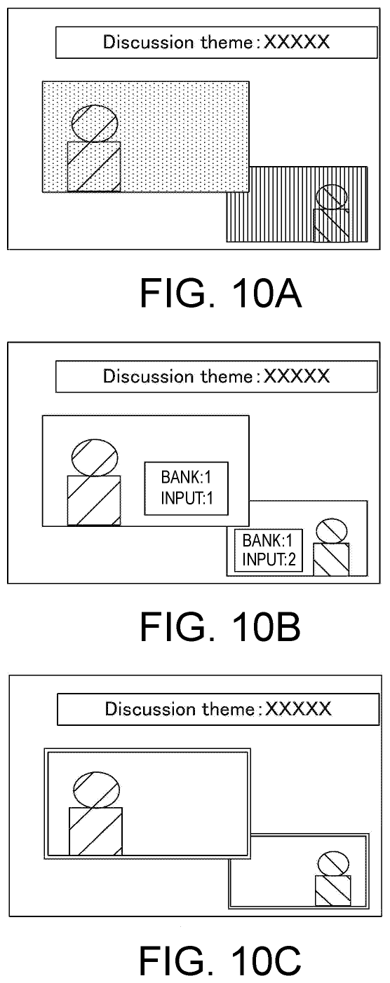

For example, as shown in FIG. 10A, hatching or color may be applied depending on the input source of the no-signal media data and the selected bank. For example, hatching with shading and pink color may be applied to the media data with “Bank 1” selected and inputted from the first input terminal 16a. Hatching with diagonal lines and yellow color may be applied to the media data with “Bank 1” selected and inputted from the second input terminal 16b.

In this manner, by configuring the no-signal thumbnails in different forms depending on the input source and the selected bank, the user H can easily learn to which input source the no-signal thumbnail corresponds and which bank is selected. Further, in the case where the media data partially overlap with each other, the corresponding no-signal thumbnails also partially overlap with each other. Since the forms of the no-signal thumbnails are different from each other, the user H can easily recognize the boundary between the no-signal thumbnails.

Alternatively, as shown in FIG. 10B, the name of the input source of the no-signal media data and the name of the selected bank may be added to the no-signal thumbnail. With this configuration as well, it is possible to allow the user H to easily learn to which input source the no-signal thumbnail corresponds and which bank is selected. Furthermore, as shown in FIG. 10C, the end part of the no-signal thumbnail may be configured in an emphasized form, such as configuring the end part of the no-signal thumbnail in a double line, a thick line, etc. With this configuration as well, it is possible to allow the user H to more easily recognize the boundary between the no-signal thumbnails. In addition, while no-signal thumbnails are displayed in different forms depending on the input source in the composite video Sc displayed on the LCDs 3b and 4b, the no-signal thumbnails may be displayed in the same form regardless of the input source in the composite video Sc outputted to the projector 22 or the distribution PC 23.

In the above embodiment, in the case where the program output is selected as the setting mode, display and output of the no-signal thumbnail are prohibited, but the disclosure is not limited thereto. Display and output of the no-signal thumbnail may also be performed even in the case where the program output is selected as the setting mode. At this time, the no-signal thumbnail displayed in the display area V and on the preview buttons C1 to C6 in the case where the preview output is selected as the setting mode, and the no-signal thumbnail displayed and outputted in the case where the program output is selected as the setting mode may be configured in different forms. For example, the no-signal thumbnail in the case where the preview output is selected as the setting mode may be configured as a simple image for people concerned, and the no-signal thumbnail in the case where the program output is selected as the setting mode may be configured as an image including an image character or an event name for the viewers.

Further, in the case where the program output is selected as the setting mode, while displaying the no-signal thumbnail in the display area V, it also possible not to display the no-signal thumbnail to the projector 22 or the distribution PC 23. With this configuration, it is possible to suppress a situation in which unnecessary no-signal thumbnails are displayed to the viewers.

In the above embodiment, it has been described that the setting mode and the output destination of the composite video Sc may be set independently on each of the LCDs 3b and 4b, but the disclosure is not limited thereto. For example, in the case where the “preview output” is set as the setting mode on one of the LCDs 3b and 4b, the “program output” may be set as the setting mode on the other of the LCDs 3b and 4b. Conversely, in the case where the “program output” is set as the setting mode on one of the LCDs 3b and 4b, the “preview output” may be set as the setting mode on the other of the LCDs 3b and 4b. With this configuration, by changing the setting mode of the LCDs 3b and 4b, one of the LCDs 3b and 4b is always set to the “program output”, so it is possible to display the composite video Sc outputted to the output destination corresponding to the LCDs 3b and 4b.

Furthermore, in the case where the “projector 22” or the “distribution PC 23” is set as the output destination of the composite video Sc of one of the LCDs 3b and 4b, the output destination of the composite video Sc of the other of the LCDs 3b and 4b may also be set to the same output destination as the set output destination of the composite video Sc of the one of the LCDs 3b and 4b. With this configuration, changes in the associated output destinations of the composite videos Sc of the LCDs 3b and 4b can be performed by simply changing the output destination of the composite video Sc of one of the LCDs 3b and 4b. For example, when the user H switches the output destination of the composite video Sc of the left LCD 3b from the “projector 22” to the “distribution PC 23”, the user H can change the output destination of the composite video Sc of the right LCD 4b to the “distribution PC 23” without any additional operations.

Alternatively, when the setting modes of the LCDs 3b and 4b are both set to the “program output”, in the case where the output destination of the composite video Sc of one of the LCDs 3b and 4b is changed to the “projector 22”, the output destination of the composite video Sc of the other of the LCDs 3b and 4b may be changed to the “distribution PC 23”; conversely, in the case where the output destination of the composite video Sc of one of the LCDs 3b and 4b is changed to the “distribution PC 23”, the output destination of the composite video Sc of the other of the LCDs 3b and 4b may be changed to the “projector 22”. Accordingly, since the user H can monitor the composite videos Sc outputted to the “projector 22” and the “distribution PC 23” respectively with the LCDs 3b and 4b, it is possible to suppress a situation in which two types of composite videos Sc are outputted to one output destination.

Furthermore, display of the stage distribution button St and the net distribution button Nt may be omitted from the LCDs 3b and 4b. In that case, for example, the output destination of the composite video Sc of the left LCD 3b may be fixed to the “projector 22”, and the output destination of the composite video Sc of the right LCD 4b may be fixed to the “distribution PC 23”. Alternatively, the output destination of the composite video Sc of the left LCD 3b may be fixed to the “distribution PC 23”, and the output destination of the composite video Sc of the right LCD 4b may be fixed to the “projector 22”. Alternatively, the output destinations of the composite videos Sc of both the LCDs 3b and 4b may be fixed to the “projector 22” or may be fixed to the “distribution PC 23”.

In addition, the preview output button Pr and the program output button Pg may be omitted from the LCDs 3b and 4b. In that case, for example, the setting mode of the left LCD 3b may be fixed to the “preview output”, and the setting mode of the right LCD 4b may be fixed to the “program output”. Alternatively, the setting mode of the left LCD 3b may be fixed to the “program output”, and the setting mode of the right LCD 4b may be fixed to the “preview output”. Alternatively, the setting modes of both the LCDs 3b and 4b may be fixed to the “preview output” or may be fixed to the “program output”.

In the above embodiment, it has been described that no-signal thumbnails are stored in the thumbnail data 11b for all input terminals including the first input terminal 16a, the second input terminal 16b, and the third input terminal 16c, but the disclosure is not limited thereto. There may also be an input terminal for which a no-signal thumbnail is not stored in the thumbnail data 11b, e.g., not storing a no-signal thumbnail of the first input terminal 16a. In that case, if an input terminal for which a no-signal thumbnail is not stored in the thumbnail data 11b does not have a signal, the image or video acquired from this input terminal may be directly displayed in the composite video Sc displayed on the preview buttons C1 to C6 and in the display area V of the LCDs 3b and 4b on which the preview output is selected as the setting mode.

In the above embodiment, it has been described that in the case where the signal from the input terminal is “no-signal”, media data cannot be normally acquired, but the disclosure is not limited thereto. For example, similarly, in the case where it is determined that the display content of media data is distorted due to noise mixed into the signal from the input terminal, a no-signal thumbnail may also be displayed as a case where media data cannot be normally acquired. Similarly, in other cases where media data cannot be normally acquired from the input terminal, a no-signal thumbnail may also be displayed.

In the above embodiment, pre-created no-signal thumbnails are stored in the thumbnail data 11b, but the disclosure is not limited thereto. No-signal thumbnails created by the user H with the presentation PC 21 or the like may also be stored to the thumbnail data 11b.

In the above embodiment, the video cameras 20a and 20b and the presentation PC 21 output images or videos to the video switcher 1, but the disclosure is not limited thereto. For example, images or videos may also be inputted from other devices such as a hard disk recorder or a game console. Further, images or videos may also be inputted from the Internet W and the like via the communication device 18. Alternatively, images or videos pre-stored in the flash ROM 11 of the video switcher 1 may also be used. Images or videos inputted from outside in this manner may also be stored to the flash ROM 11 of the video switcher 1.

Furthermore, in the above embodiment, the input sources that input images or videos to the video switcher 1 are of three types including the video cameras 20a and 20b and the presentation PC 21, but the disclosure is not limited thereto, and there may also be less than three types or more than three types of input sources. For example, images or videos may also be inputted from two video cameras 20a and 20b, one presentation PC 21, one game console, and the Internet W.

Further, the output destination to which the composite video Sc is outputted from the video switcher 1 is not limited to the projector 22 and the distribution PC 23. For example, the composite video Sc may also be outputted to other devices such as a television connected to the first input terminal 16a or the like of the video switcher 1, or a smartphone connected via the Internet W.

Furthermore, in the above embodiment, it has been described that the output destinations of the composite video Sc outputted from the video switcher 1 are of two types including the projector 22 and the distribution PC 23, but the disclosure is not limited thereto, and there may also be less than two types or more than two types of output destinations. For example, the composite video Sc may also be outputted to two projectors 22, one television, and the distribution PC 23.

In the above embodiment, it has been described that the network to which the distribution PC 23 and the distribution destination PCs 24 are connected is the Internet W, but the disclosure is not limited thereto. For example, the network may also be an intranet in which the distribution destination PCs 24 to be connected are limited, or any other network constructed by any communication system.

In the above embodiment, the video switcher 1 is provided with two combinations of touch panels and LCDs, including a combination of the left touch panel 3a and the left LCD 3b and a combination of the right touch panel 4a and the right LCD 4b, but the disclosure is not limited thereto. The combination of the touch panel and the LCD provided in the video switcher 1 may also be one combination or three or more combinations. For example, in the case where there is one combination of the touch panel and the LCD, the “preview output” is first selected as the setting mode to perform configuration setting of the composite video Sc, and then by selecting the “program output” as the setting mode, the completed composite video Sc can be outputted to the corresponding output destination.

Alternatively, one combination of the touch panel and the LCD may be provided in the video switcher 1, the region of the one combination of the touch panel and the LCD may be divided into two or more parts, and in each divided region, the setting mode and the output destination may be specified to perform setting of the composite video Sc.

Further, it has been described that the stage distribution button St, the net distribution button Nt, the preview output button Pr, the program output button Pg, and the bank buttons B1 to B3 are operators displayed on the LCDs 3b and 4b, but the disclosure is not limited thereto. A part or all of these operators may also be composed of physical operators such as the setting buttons 2.

In the above embodiment, the video switcher 1 has been illustrated as the device executing the video processing program 11a, but the disclosure is not limited thereto. For example, the video processing program 11a may also be executed by an information processing device such as a PC, a smartphone, or a tablet terminal.

What is claimed is:

1. A video processing device that outputs a composite video, wherein the composite video is a video in which a plurality of media data are arranged, and the media data is composed of at least one of an image and a video, the video processing device comprising:
an input terminal in which the media data to be arranged in the composite video is inputted;
a substitution display memory that stores substitution display data for each one of the input terminal, wherein the substitution display data is composed of an image or a video representing a content of the media data that should be inputted in the input terminal; and
at least one processor, configured to:
determine whether the media data has been normally inputted in the input terminal, and
acquire the substitution display data corresponding to the input terminal from the substitution display memory and display, in the composite video, the substitution display data acquired corresponding to the input terminal in place of the media data from the input terminal, in a case of determining that the media data has not been normally inputted in the input terminal.

2. The video processing device according to claim 1, further comprising:
a display device that displays the composite video; and
an external output device that outputs the composite video to outside, wherein
the at least one processor is configured to:
display, in the composite video, the substitution display data acquired corresponding to the input terminal in place of the media data from the input terminal, in a case of determining that the media data has not been normally inputted in the input terminal when displaying the composite video on the display device, and
prohibit the substitution display data from being displayed in the composite video, in a case of outputting the composite video to the external output device.

3. The video processing device according to claim 2, wherein
the at least one processor is configured to display, in the composite video, a substitution display data different from the substitution display data displayed on the display device in place of the media data from the input terminal, in a case of determining that the media data has not been normally inputted in the input terminal when outputting the composite video to the external output device.

4. The video processing device according to claim 1, wherein the substitution display data stored in the substitution display memory are in forms different from each other.

5. The video processing device according to claim 2, wherein the substitution display data stored in the substitution display memory are in forms different from each other.

6. The video processing device according to claim 3, wherein the substitution display data stored in the substitution display memory are in forms different from each other.

7. The video processing device according to claim 4, further comprising a bank memory that stores, for each of a plurality of banks, a plurality of pieces of scene information for constructing the composite video from the media data, wherein
the composite video is created based on the scene information acquired from the bank memory and the media data inputted in the input terminal,
the at least one processor is configured to acquire a selected bank,
the substitution display data stored in the substitution display memory are in forms different from each other depending on the bank of the bank memory and the input terminal, and
the at least one processor is configured to acquire, from the substitution display memory, the substitution display data corresponding to both the acquired bank and the input terminal in which it has been determined that the media data has not been normally inputted.

8. The video processing device according to claim 5, further comprising a bank memory that stores, for each of a plurality of banks, a plurality of pieces of scene information for constructing the composite video from the media data, wherein
the composite video is created based on the scene information acquired from the bank memory and the media data inputted in the input terminal,
the at least one processor is configured to acquire a selected bank,
the substitution display data stored in the substitution display memory are in forms different from each other depending on the bank of the bank memory and the input terminal, and
the at least one processor is configured to acquire, from the substitution display memory, the substitution display data corresponding to both the acquired bank and the input terminal in which it has been determined that the media data has not been normally inputted.

9. The video processing device according to claim 6, further comprising a bank memory that stores, for each of a plurality of banks, a plurality of pieces of scene information for constructing the composite video from the media data, wherein
the composite video is created based on the scene information acquired from the bank memory and the media data inputted in the input terminal,
the at least one processor is configured to acquire a selected bank,
the substitution display data stored in the substitution display memory are in forms different from each other depending on the bank of the bank memory and the input terminal, and
the at least one processor is configured to acquire, from the substitution display memory, the substitution display data corresponding to both the acquired bank and the input terminal in which it has been determined that the media data has not been normally inputted.

10. The video processing device according to claim 1, wherein the substitution display data stored in the substitution display memory is in a form in which an end part of the substitution display data is emphasized.

11. The video processing device according to claim 2, wherein the substitution display data stored in the substitution display memory is in a form in which an end part of the substitution display data is emphasized.

12. The video processing device according to claim 3, wherein the substitution display data stored in the substitution display memory is in a form in which an end part of the substitution display data is emphasized.

13. A computer-readable recording medium recording a video processing program that causes a computer comprising an input terminal and a memory to execute a processing of outputting a composite video, wherein the composite video is a video in which a plurality of media data are arranged, and the media data is composed of at least one of an image and a video,
the media data to be arranged in the composite video is inputted in the input terminal, and
the memory is operated as a substitution display memory that stores substitution display data for each of the input terminal, and the substitution display data is composed of an image or a video representing a content of the media data that should be inputted in the input terminal, wherein
the video processing program causes the computer to:
determine whether the media data has been normally inputted in the input terminal, and
acquire, from the substitution display memory, the substitution display data corresponding to the input terminal, and display, in the composite video, the substitution display data acquired corresponding to the input terminal in place of the media data from the input terminal, in a case of determining that the media data has not been normally inputted in the input terminal.

14. The computer-readable recording medium recording a video processing program according to claim 13, wherein
when displaying the composite video on a display device, in a case of determining that the media data has not been normally inputted in the input terminal, the substitution display data acquired corresponding to the input terminal is displayed in the composite video in place of the media data from the input terminal, and
in a case of outputting the composite video to an external output device, the substitution display data is prohibited from being displayed in the composite video.

15. A video processing method comprising:
determining whether a media data has been normally inputted from an input terminal, wherein the media data is composed of at least one of an image and a video and is to be arranged in a composite video,
acquiring, from a memory, a substitution display data corresponding to the input terminal in a case of determining that the media data has not been normally inputted from the input terminal, wherein the substitution display data is composed of an image or a video representing a content of the media data that should be inputted in the input terminal; and
displaying, in the composite video, the substitution display data acquired corresponding to the input terminal in place of the media data from the input terminal.

16. The video processing method according to claim 15, further comprising:
displaying, in the composite video, the substitution display data acquired corresponding to the input terminal in place of the media data from the input terminal, in a case of determining that the media data has not been normally inputted in the input terminal when displaying the composite video on a display device, and
prohibiting the substitution display data from being displayed in the composite video in a case of outputting the composite video to an external output device.

17. The video processing method according to claim 16, further comprising:
displaying, in the composite video, a substitution display data different from the substitution display data displayed on the display device in place of the media data from the input terminal, in a case of determining that the media data has not been normally inputted in the input terminal when outputting the composite video to the external output device.

18. The video processing method according to claim 15, wherein the substitution display data stored in the memory are in forms different from each other.

19. The video processing method according to claim 18, wherein
the memory stores bank data in which a plurality of pieces of scene information are stored for each of a plurality of banks, and the scene information constitutes the composite video from the media data,
the composite video is created based on the scene information acquired from the bank data and the media data inputted in the input terminal, and
the substitution display data stored in the memory are in forms different from each other depending on the bank of the bank data and the input terminal, wherein
the video processing method further comprises:
acquiring a selected bank; and
acquiring, from the memory, the substitution display data corresponding to both the acquired bank and the input terminal in which it has been determined that the media data has not been normally inputted.

20. The video processing method according to claim 15, wherein the substitution display data stored in the memory is in a form in which an end part of the substitution display data is emphasized.
